(19) United States
(12) Patent Application Publication
(10) Pub. No.: US 2014/0268866 A1
(43) Pub. Date: Sep. 18, 2014

(54) Decoration of water lantern

(71) Applicant: CHIN-SHENG YANG, Tainan City (TW)

(72) Inventor: CHIN-SHENG YANG, Tainan City (TW)

(21) Appl. No.: 13/831,640

(22) Filed: Mar. 15, 2013

(51) Int. Cl. F21V 33/00

(52) U.S. Cl. CPC F21V 33/0028
USPC 362/605

(57) ABSTRACT

The present invention provides a decoration of water lantern which mainly comprises a body, a light guide unit, and a base. The body can be filled with flow liquid inside. The light guide unit comprises a light guide plate provided inside the body, the light guide plate comprises an incident light portion contacting with the bottom of the body, and the surface of the light guide plate is provided with patterns. The base is used to fasten the body. A circuit module is provided inside the base. The circuit module is provided with at least one light-emitting diode corresponding to the incident light portion.

### (a) TECHNICAL FIELD OF THE INVENTION

The present invention generally relates to a decoration of water lantern, and more particularly to a water lantern design of visual decoration objects used in the environmental space.

(b) DESCRIPTION OF THE PRIOR ART

Generally, decorative accessories, such as picture frames, toys, jewelry, etc, are usually put on the desktop in daily life. These decorative accessories only have static functions of beautiful views. Therefore, there is a water lantern design with brightness chips, bright powders or decorations inside, which uses artificial inversely shake or allows the brightness chips, the bright powders or the decorations inside to generate the visual perception of the liquid flow using the power. Also, it has different visual effects due to various objects inside the water lantern, which allows it having a space for expansion, extending the effects of a various visual changes, or having versatility and interesting developments. Therefore, the water lantern design is a subject needed for the R&D of the environmental decorations to study.

In view of this, because the creators have engaged in the research of the decorations for many years, provide a decoration having brilliant visual effects, which is more beautiful and interesting. After continual trial and improvements, the present invention is provided.

### SUMMARY OF THE INVENTION

The primary purpose of the present invention is to provide a decoration of water lantern which has different visual effects and improves the product competitiveness.

To achieve the above purpose, a decoration of water lantern according to the present invention mainly comprises a body, a light guide unit, and a base. The body comprises a translucent casing and a translucent bottom cap forming a sealed container, which is available for filling with flow liquid inside. The light guide unit comprises a first light guide plate provided inside the body, the first light guide plate comprises an incident light portion contacting with the bottom cap, and the surface of the first light guide plate is provided with patterns. The base has an upward opening, which is used to fasten the body. A circuit module is provided inside the base, and the circuit module is provided with at least one light-emitting diode corresponding to the incident light portion.

In this way, the light-emitting diode generates a flat light source through the incident light portion and then through the light guide plate, which makes the surface pattern of the light guide plate to have brightness. Moreover, when looking inside from outside, the patterns have the visually enlarged effects due to the liquid inside the body, which improves the competitiveness of the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a three dimensional exploded view showing the present invention

FIG. 2 is a three dimensional diagram showing the present invention.

FIG. 3 is a plane sectional view showing the present invention.

FIG. 4 is a plane sectional view in the other direction showing the present invention.

FIG. 5 and FIG. 6 are the schematic diagrams of the present invention applied in cork.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Firstly, referring to FIGS. 1-3, which show the three dimensional exploded view, the exterior, and the sectional view of the present invention, the decoration of water lantern 10 mainly comprises a body 1, a light guide unit 2, and a base 3. The body 1 is provided above the base 3. The light guide unit 2 is fixed inside the body 1.

The body 1 is composed of a hollow casing 11 and a translucent bottom cap 12 forming a sealed container, which is filled with brightness chips, bright powders, or other floating objects. Then, inject the liquid through a hole 14 reserved on the bottom cap 12 and seal the hole 14. In the present embodiment, the exterior of the body 1 can be sphere, cuboid, or other three-dimensional shape, but not limited.

The light guide unit 2 comprises at least one light guide plate 21 provided inside the body 1. The light guide plate 21 comprises an incident light portion 22 contacting with the bottom cap 12. The incident light portion 22 is fixed inside the body 1 by bonding, fitting, etc. In the present invention, it is fixed by inserting. The bottom cap 12 comprises slots 13 corresponding to each incident light portion 22, which are used for the incident light portion 22 inserting in.

The surface of the each light guide plate 21 is provided with patterns 23. The patterns 23 can be occasional patterns or texts. In the present invention, the shapes, number and materials of the light guide plate 21 are not limited. In the present embodiment, the shape of the light guide plate 21 is illustrated with circle, and the number is two provided in parallel. The incident light portion 22 is extended from the light guide plate 21. Each incident light portion 22 is staggered, and the shape of the incident light portion 22 is not limited, as shown in FIG. 1, that is multiple protrusions with parallel intervals or single protrusion extends downward.

The base 3 has an upward opening 31, which is used to fasten the body 1. A circuit module 32 is provided inside the base 3. The circuit module 32 is provided with a light-emitting diode 33 corresponding to the incident light portion 22. The circuit module 32 further comprises a control system (not shown), which is used to control the flashing sequence and the light color changes of each light-emitting diode 33.

In this way, each light emitting diode 33 generates a direct light through the incident light portion 22, which emits to each light guide plate 21 and allows the patterns 23 on the surface of the light guide plate 21 to produce brightness. Furthermore, when looking inside from outside of the body 1, the patterns 23 have the visually enlarged effects due to the liquid inside the body 1.

Referring to FIG. 4, the light source route of the light-emitting elements 33 is direct. Therefore, the periphery of the translucent panels 21 is luminous. Moreover, the present invention controls the flashing sequence and time of the light-emitting elements 33, which can change with various light colors, so that the patterns 23 of each light guide plate 21 show such dynamic effects.

Referring to FIGS. 5 to 6, they show the flat appearance and application diagram of the other embodiment according to the present invention. The present invention further comprises a plug body 4 provided under the base 3. The plug body is tapered, which is soft and tough material, such as rubber, silicone rubber or cork, etc. The fixed way on the base 3 is not limited, which can be bonding, fitting, locking, etc. In the present invention, it is fixed by inserting. An embedded slot 41 is provided above the plug body 4, which is used for the base 3 inserting in. The part of the plug body 4 contrary to the embedded slot 41 can be actively inserted into the mouthpiece 51 of the container 5, which is used as cork.

In addition, the light-emitting elements 33 are controlled by a switch (not shown). The power source can be correspondingly assembly battery, AC or DC power. The power source can be any kinds and not focused in the patent applications of the present invention, so it is not described in detail.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A decoration of water lantern, mainly comprising:
a body, which comprises a translucent casing and a translucent bottom cap forming a sealed container, which is available for filling with flow liquid inside;
a light guide unit, which comprises a first light guide plate provided inside the body, the first light guide plate comprising an incident light portion contacting with the bottom cap, and the surface of the first light guide plate provided with patterns; and
a base, which has an upward opening, used to fasten the body, a circuit module provided inside the base, and the circuit module provided with at least one light-emitting diode corresponding to the incident light portion.

2. The decoration of water lantern according to claim 1, wherein the bottom cap comprises a slot, which is used for the incident light portion of the first light guide plate inserting in.

3. The decoration of water lantern according to claim 1, wherein it further comprises a plug body provided under the base.

4. The decoration of water lantern according to claim 1, wherein the light guide unit further comprises a second light guide plate provided inside the body, the second light guide plate comprises a incident light portion contacting with the bottom cap, the surface of the second light guide plate provided with patterns, and the circuit module provided with a light-emitting diode corresponding to the incident light portion of the second light guide plate.

5. The decoration of water lantern according to claim 4, wherein the bottom cap is provided with a slot corresponding to the incident light portion of the second light guide plate.
